(19) United States
(12) Patent Application Publication
(10) Pub. No.: US 2023/0187616 A1
(43) Pub. Date: Jun. 15, 2023

(54) THE USAGE OF FATTY ACID IN THE PREPARATION OF LITHIUM-ION BATTERIES AND THE METHOD FOR MANUFACTURING ELECTRODE MATERIALS

(71) Applicant: SHENZHEN ORI TECHNOLOGY CO., LIMITED, Shenzhen, Guangdong (CN)

(72) Inventors: YAN LI, Shenzhen, Guangdong (CN); HAN GAO, Shenzhen, Guangdong (CN); LE GE, Shenzhen, Guangdong (CN); YU-XIN GAO, Shenzhen, Guangdong (CN); RU-HAO LIU, Shenzhen, Guangdong (CN); YI-HAN LIU, Shenzhen, Guangdong (CN)

(21) Appl. No.: 17/925,072

(22) PCT Filed: May 26, 2020
(86) PCT No.: PCT/CN2020/092306

§ 371 Date: Nov. 14, 2022

(30) Foreign Application Priority Data
May 15, 2020 (CN) 202010417959.0

(51) Int. Cl. H01M 4/36; H01M 10/0525; H01M 4/62; H01M 4/131; H01M 4/505; H01M 4/525; H01M 4/58; H01M 4/485; H01M 4/38; C01G 53/00; C01G 51/00; C01B 25/45; C01G 23/00; C01B 33/02; C01B 33/113; C01G 51/04

(52) U.S. Cl. CPC H01M 4/366; C01B 25/45; C01B 33/02; C01B 33/113; C01G 23/005; C01G 51/04; C01G 51/42; C01G 53/50; H01M 4/62; H01M 4/131; H01M 4/386; H01M 4/485; H01M 4/505; H01M 4/525; H01M 4/5825; H01M 10/0525; C01P 2002/72; C01P 2002/88; C01P 2004/62; C01P 2004/64; C01P 2004/84; C01P 2006/40

(57) ABSTRACT

The use of a C10~C34 fatty acids compound in the preparation of a the electrode materials for lithium-ion battery improves the coating uniformity of electrode materials prepared with solid-state method. The fatty acid provided by the invention is a dispersant, which achieves the uniformly dispersion of the coating material on the surface of battery material, and significantly increases the coating uniformity of the electrode material coated with solid-state method, it greatly improves the feasibility of manufacturing the electrode material of lithium-ion battery with solid-state method, and is conducive to the more economical and simpler manufacture of electrode material.

### TECHNICAL FIELD

The invention relates to the usage of organic acid in the manufacture of electrode materials, in particular to the usage of fatty acid as dispersant in the preparation of electrode materials with solid-state method, and a method for preparing electrode materials for lithium-ion batteries

### BACKGROUND

In recent years, lithium-ion batteries with high energy density are widely applied in large energy storage devices, consumer digital products and new energy electric vehicles. In particular, with vigorous development of new energy electric vehicles, the demand for high energy density lithium-ion battery electrode materials is increasing. For example, the electrode material whose main content is nickel cobalt manganese is considered the most promising electrode material for power battery in the industry because of its high energy density. But at the same time, the surface of such electrode materials also has high reactivity. In contact with electrolyte during charge and discharge cycle of battery, the interface stability between the surface of electrode material and electrolyte decreases, resulting in the reduction of safety performance and cycle life of electrode material. Therefore, by establishing an effective protective film on the surface of the electrode material, a stable interface can be established between the surface of the electrode material and the electrolyte, hence improve the safety performance and cycle life of the electrode material. One way to realize this protective film is to cover a layer of coating material on the surface of electrode material to achieve a uniform coating effect. However, how to cover the electrode material surface with a simple, high-quality and uniform coating material has become the key technology to realize mass industrial production. Electrode materials of battery are coated by various means in the industry, and the most representative coating methods include liquid state method and solid-state method.

CN105914356A discloses a method for coating cathode material of lithium-ion battery with liquid state method. Firstly, the electrode material and surfactant are dispersed into the solvent, and the electrode material is evenly dispersed in the solution by means of ultrasonic and magnetic stirring to obtain the suspension. Keep the ultrasonic and magnetic stirring in the suspension, and gelatinize the coating materials, such as injecting Al2O3 gel into it. Keep the mixed suspension at a temperature of 30-80° C., and evaporate all the solvent, and then dry and synthesize it into the electrode material for coating.

CN107768642A discloses an electrode material of lithium-ion battery with double-layer coating on the surface prepared with liquid state method. Firstly, the organic complexing agent is used as the auxiliary agent. The lithium rich layered oxide is coated on the material surface with sol-gel method, and then aluminum fluoride is coated with liquid state method. And through sintering at high temperature, a double-layer coated ternary lithium-ion battery material is prepared.

CN108767221A discloses a method of coating titanium aluminum composite oxide on the surface of electrode material of lithium-ion battery with a method of mechanical mixing and solid-state synthesis. According to this method, the cathode material is mixed with titanium aluminum oxide and then ball milled, and then sintered to obtain the modified material, so as to improve its stability in electrolyte and improve the structural stability and cycle life of the material.

The coating effect largely depends on the dispersion effect of the coating material. The above technical schemes focus on how to better disperse the coating material and realize the uniform coating effect in the subsequent preparation process. The liquid-state coating method is to finally form a relatively complete and uniform coating surface by mixing and dispersing the coating material and electrode material in the liquid medium, followed by drying and sintering. However, the process of the liquid-state method itself is complex, which increases the cost of producing cathode materials and is not the best choice for large-scale production.

Due to its simple process, solid-state coating can be used as an economic coating method in large-scale industrial production. Usually, after the coating material is mixed with the electrode material and heated to high temperature for reaction, the coating will be formed on the surface of the electrode material. The distribution uniformity of coating material largely depends on the dispersion effect of coating material in the mixing process. Generally, the surface coating of electrode materials coated with solid-state method is not uniform enough, which greatly reduces the effect of improving material properties.

### SUMMARY

One objection of the invention is to provide a compound for preparing electrode material of lithium -ion battery and improve the uniformity of coating electrode material with solid-state method.

Another objection of the invention is to provide a compound for preparing electrode material of lithium-ion battery, prepare lithium-ion electrode material on demand according to the requirements of initial discharge capacity and cycle life, and realize personalized manufacturing.

Another objection of the invention is to provide a method for preparing the electrode material of lithium-ion battery, so as to realize the uniform coating of electrode material simply and efficiently.

And another objection of the invention is to provide a method for preparing electrode material of lithium-ion battery, and to prepare electrode material of lithium-ion battery with high safety performance and cycle life.

A compound, which is C10~ C34 fatty acid, is used to prepare electrode materials for lithium-ion battery and improve the coating uniformity of electrode materials made with solid-state method.

The compound provided in the invention is applied as a dispersant in the preparation of electrode materials for lithium-ion battery, that is, the coating material is uniformly dispersed on the surface of battery material. The compound comprises at least one C, H and O element and at least one carboxyl group. For example, but not limited to saturated or unsaturated monobasic acids, saturated or unsaturated binary acids, and saturated or unsaturated ternary acids, the number of monoatoms contained is greater than 10, especially 10~34, such as 10, 11, 12, 13, 14, 15, 16, 17, 18, 19, 20, 21, 22, 23, 24, 25, 26, 27, 28, 29, 30, 31, 32, 33 and 34.

Another embodiment of the compound is a saturated fatty acid, which includes substituents such as, but not limited to, hydroxyl, sulfhydryl, amino, ester, alkane, alkenyl and alkyne.

Another embodiment of the compound is an unsaturated fatty acid, which includes at least one saturated double bond or triple bond, and substituents such as but not limited to hydroxyl, sulfhydryl, amino, ester, alkane, alkenyl and alkyne.

In order that the electrode material of lithium-ion battery has higher thermal stability and cycle life, the characteristics that fatty acids contain liquid phase and solid-state at room temperature is used, that is, with the increase of carbon chain length of fatty acids, fatty acids gradually change from liquid-state to solid-state. That is, when the number of carbon atoms of saturated fatty acids is greater than or equal to 10, the fatty acids become solid at room temperature. Therefore, it can cooperate with the method of solid-state coating battery material, and has practical credibility, and can realize more economical and simpler manufacture of electrode material.

Another embodiment of the compound is shown in CH₃(CH₂)ₙCOOH, where n is an integer from 8 to 32, such as 8, 9, 10, 11, 12, 13, 14, 15, 16, 17, 18, 19, 20, 21, 22, 23, 24, 25, 26, 27, 28, 29, 30, 31 and 32.

When solid-state method is adopted for preparing electrode materials, the above compounds are firstly mixed with coating materials, and then used to coat lithium-ion battery materials. The compound volatilizes in the heating process, and the compound itself will not have any effect on the materials of lithium-ion battery.

When solid-state method is adopted for preparing battery material, the above compounds can be mixed with the coating material in various proportions, which can achieve coating of lithium-ion battery material, and the coating material is evenly distributed, which not only provides the feasibility for the study of balancing the initial energy density of the electrode material and improving the cycle life of the electrode material, but also electrode materials of lithium-ion battery can be prepared on demand to realize personalized manufacturing according to the requirements of the initial discharge and cycle life.

In the preparation of electrode materials of lithium-ion battery, it is usually necessary to coat the battery materials with coating materials so as to improve the performance of electrode materials, the common materials are but not limited to metal oxides (such as but not limited to MgO, ZnO, CaO, BaO, Al₂O₃, Fe₂O₃, La₂O₃, TiO₂ and ZrO₂), metal fluorides (such as but not limited to LiF, MgF₂, CaF₂ and AlF₃, etc.) and metal carbonates (such as but not limited to Li₂CO₃, MgCO₃, CaCO₃ and Al₂(CO₃)₃, etc.). These materials are applied to the invention alone or in combination.

As is known to technicians, lithium-ion battery materials generally include materials for manufacturing positive electrodes and those for manufacturing negative electrodes. Materials used for manufacturing positive electrodes include: layered materials as shown in Li_{1±m}NiₓCo_{y}Mn_{z}M_{1-x-y-z}O₂ (where M is a trace element, and M can be Cr, Mg, Al, Ti, Zr, Zn, CA, Nb and W, etc.; m is 0.005 to 0.2; x, y and Z are independently selected from any number from 0 to 1, and the sum of x, y and z is 0.9~1, such as x = 0.5, y = 0.2, z = 0.3 or x = y = z = 0.333), and olivine materials as shown in LiNPO₄ (where N is elements such as Fe, Co, Mn and Ni) and spinel materials are shown in LiQO₄ (where Q is elements such as Mn, Ni and Co, which are applied to the invention alone or in combination). The materials used for manufacturing the negative electrode including: intercalation negative electrode materials, such as soft carbon, hard carbon and graphite materials; alloying negative electrode materials, i.e. metals and their alloys that can react with lithium, including Si, Sb, Zn, Al, Ge and Zn; conversing negative electrode materials, such as Co₃O₄, MnO₂, MoO₂ and FeP; spinel materials, i.e. Li₄Ti₅O₁₂ ,they all can be seen as the compounds in the invention to disperses the coating materials on their surfaces.

The method for preparing electrode material of lithium-ion battery provided in the invention is to mix the compound with the coating material according to the weight ratio of 1:1~ 20 to prepare the coating material, then it is mixed with the lithium-ion battery material, and the coating material evenly dispersed on the surface of electrode material of the lithium-ion battery is prepared after sintering (temperature: 200° C.~1000° C.).

The form of the lithium-ion battery material applied to the preparation method of the invention is preferably powder.

The form of the coating material applied to the preparation method of the invention is preferably powder, and the particle size is, for example, 10 nm~500 nm, especially 10 nm~100 nm.

Another method for preparing electrode materials for lithium-ion battery, comprising:

Firstly, mix the compound with the coating material (such as using means of ball milling or mechanical mixing) to prepare the coating material, with the mass percentage of fatty acid controlled to be 1-20%;

Then, blend the coating material with lithium-ion battery material, and the dosage ratio of coating material to lithium-ion battery material is 0.1~10 wt%, especially 0.1~5 wt%;

Then, sinter between 200° C.~1000° C. (such as raising temperature at the rate of 1~10° C./min) and hold for 1 \~24 hours, so as to complete the solid-state reaction between the coating material and the lithium-ion battery material;

Finally, disperse and sieve the prepared product to obtain the electrode material of lithium-ion battery.

The beneficial effects of the invention are:

In the invention, C10~C34 fatty acids are as dispersant to realize uniform dispersion of the coating material on the surface of the battery material, which significantly improves the uniformity of the electrode material coated with the solid-state method, greatly improves the feasibility of manufacturing the electrode material of lithium-ion battery with the solid-state method, and is conducive to manufacturing the electrode material more economically and simply.

The compound provided in the invention can quickly realize the uniform coating of electrode material of lithium-ion battery, enhance the interface stability of the electrode material of lithium-ion battery, thus enhance the safety, stability and cycle life of the material.

In the invention, C10~ C34 fatty acid are also used as regulator to realize the balance adjustment between the initial energy density of electrode material and improving the cycle life of electrode material, and realize the personalized preparation of electrode material of lithium-ion battery according to the requirements of initial discharge capacity and cycle life.

### BRIEF DESCRIPTION OF THE DRAWINGS

FIG. 1 refers to a schematic diagram of an example of the process of coating lithium -ion battery materials with solid-state method,

FIG. 2 refers to the XRD data of NCM523 material,

FIG. 3 refers to a curve of the thermogravimetric analysis (TGA) of stearic acid,

FIG. 4 refers to the elements distribution graph of uncoated NCM523,

FIG. 5 refers to the elements distribution graph of NCM523 coated with 2 wt% Al₂O₃ that is prepared without using dispersant,

FIG. 6 refers to the elements distribution graph of NCM523 coated with 2 wt% Al₂O₃ using stearic acid dispersant,

FIG. 7 refers to the comparison graph of charge/discharge curves achieved by electrode material prepared with uncoated NCM523 material and prepared with NCM523 material coated with different methods,

FIG. 8 refers to a comparison graph of Al element distribution in NCM523 coated with different amounts of Al₂O₃,

FIG. 9 refers to a comparison graph of charge/discharge curves achieved by the electrode materials prepared from NCM523 materials coated with different amounts of Al₂O₃,

FIG. 10 refers to a charge/discharge curve of NCM23 coated with Al₂O₃ using lauric acid dispersant,

FIG. 11 refers to a charge/ discharge curve of NCM811 coated with Al₂O₃ using lauric acid dispersant.

### DETAILED DESCRIPTION

The technical scheme of the invention is described in detail below in combination with the attached figures. The examples of the invention are only used to elaborate instead of limiting the technical scheme of the invention. Although the invention is described in detail with reference to the better examples, general technical personnel in this field should understand that the technical scheme of the invention can be modified or equivalently replaced without deviating from the spirit and scope of the technical scheme of the invention, and all of them shall be covered in the claims of the invention.

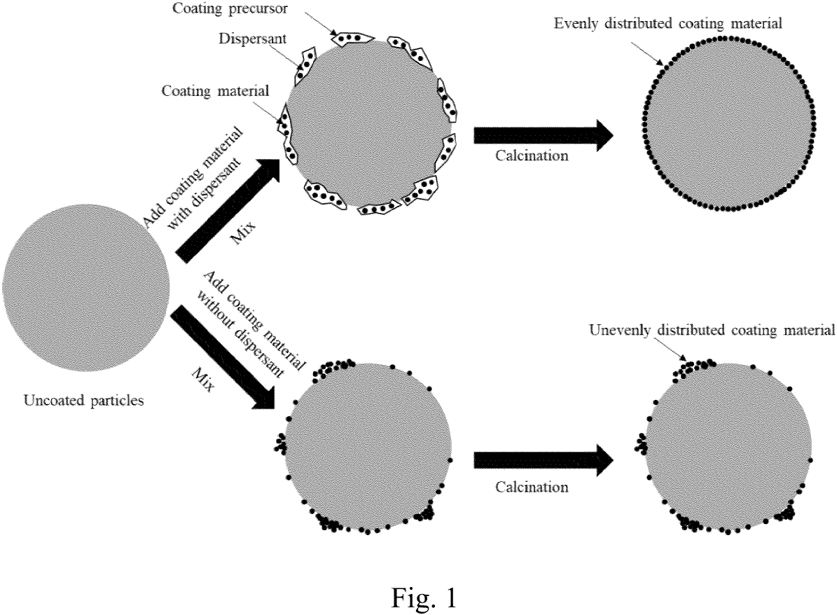

Considering the limitations of traditional liquid-state and solid-state coating methods in the industry, in these examples, C10-C34 fatty acids are used as dispersant and mechanically blended with coating materials to make packaging materials (hereinafter referred to as coating precursor or precursor in these examples) in the subsequent solid-state synthesis, the dispersant with low melting point will be liquefied first, so that the coating material can be better dispersed on the surface of the battery material, and the dispersant will decompose and volatilize during high-temperature sintering and will not remain in the prepared electrode material. FIG. 1 is a schematic diagram of an example of the process of coating lithium-ion battery materials with solid-state method. As shown in FIG. 1, the technical process and coating effect of the existing solid-state coating method and the solid-state coating method using dispersant described in the present invention. As can be seen in the figure, the application can simply and efficiently prepare the electrode material of lithium-ion battery uniformly coated with the coating material by using the dispersant.

### Example 1

(1) The fatty acids used in this example include lauric acid, myristic acid, palmitic acid, stearic acid and arachidic acid; The coating materials used include nano alumina (Al₂O₃), nano magnesium oxide (MgO), nano titanium oxide (TiO₂), nano lanthanum oxide (La₂O₃), nano zirconia (ZrO₂), nano zinc oxide (ZnO), nano aluminum fluoride (AlF₃) and nano magnesium fluoride(MgF₂). The battery materials used include LiNi_{0.5}Co_{0.2}Mn_{0.3}O₂, LiNi_{0.8}Co_{0.1}Mn_{0.1}O₂, 0.5Li₂MnO₃·0.5LiMn_{0.375}Ni_{0.375}Co_{0.25}O₂, LiCoO₂, LiFePO₄, LiNi_{0.5}Mn_{1.5}O₄, Li₄TiₛO₁₂, Si, SiO and Co₃O₄.

(2) The particle size of the coating material is 10~500 nm.

(3) Firstly, prepare the mixture of 3 g fatty acid and nano coating material, in which the mass percentage of fatty acid is controlled at 3-30%.

(4) In the above mixture, add 10 to 30 g of ball milling beads for high-speed ball milling. The ball milling time is set to 1 to 5 hours and the ball milling speed is set to 100 to 600 rmp.

(5) After mixing is over, collect the mixture of fatty acid and nano coating material, i.e. coating precursor.

(6) Take an appropriate amount of electrode material and add the corresponding coating precursor (i.e. the mixture of stearic acid and nano coating material) into it, so that the mass percentage of coating material is 0.1-5%. Put the electrode material and the coating precursor into the mixer and mix for 1~ 8 hours.

(7) Heat the above mixture to 200-1000° C. at the rate of 1~10° C./min, maintain at this temperature for 1~24 hours, and then cool to room temperature within the furnace to complete the coating process.

(8) Disperse and sieve the prepared product to obtain electrode material for coating. See Table 1 for the preparation parameters of all coating materials.

TABLE 1

| Coating precursor | | | Electrode material | Mass percentage of coating material in electrode material after coating, wt% |
|---|---|---|---|---|
| Dispersant | Coating material | Mass percentage of dispersant in coating precursor, wt% | | |
| Stearic acid | Al₂O₃ | 9 | LiNi_{0.5}Co_{0.2}Mn_{0.3}O₂ | 2 |
| Lauric acid | MgO | 12 | LiNi_{0.8}Co_{0.1}Mn_{0.1}O₂ | 2 |
| Stearic acid | TiO₂ | 15 | 0.5Li₂MnO₃·0.5LiMn_{0.375}Ni_{0.375}Co_{0.25}O₂ | 1 |
| Stearic acid | La₂O₃ | 9 | LiCoO₂ | 0.5 |
| Arachidic acid | AlF₃ | 18 | LiFePO₄ | 0.5 |
| Myristic acid | MgF₂ | 15 | LiNi_{0.5}Mn_{1.5}O₄ | 1 |
| Stearic acid | ZrO₂ | 5 | Li₄TiₛO₁₂ | 1 |
| Lauric acid | Al₂O₃ | 15 | Si | 1 |
| Palmitic acid | TiO₂ | 12 | SiO | 0.5 |
| Stearic acid | ZnO | 20 | Co₃O₄ | 1 |

### Example 2

(1) The fatty acid used in this example is stearic acid, the coating material is nano alumina (Al₂O₃), and the particle size of Al₂O₃ is 20-30 nm. The chemical formula of the electrode material used in this example is LiNi_{0.5}Co_{0.2}Mn_{0.3}O₂ (NCM523 in brief).

(2) Firstly, prepare the mixture of 3 g stearic acid and nano Al₂O₃, in which the mass percentage of stearic acid is controlled at 3-30%.

(3) In the above mixture, add 10 to 30 g of ball milling beads for high-speed ball milling. The ball milling time is set to 1 to 5 hours and the ball milling speed is set to 100 to 600 rmp.

(4) After mixing is over, collect the mixture of stearic acid and nano Al₂O₃, that is, the coating precursor.

(5) Take an appropriate amount of NCM523 and add the corresponding coating precursor (i.e. the mixture of stearic acid and nano Al₂O₃), so that the mass percentage of Al₂O₃ is 0.1-5%. Put NCM523 and coating precursor into a mixer and mix for 1 to 8 hours.

(6) Heat the above mixture to 200-1000° C. at a rate of 1-10° C./min, maintain at this temperature for 1-24 hours, and then cool to room temperature with the furnace to complete the coating process.

Disperse and sieve the reaction products to obtain the final Al₂O₃ coated NCM523.

Characterize the synthesized samples by X-ray diffraction (XRD), scanning electron microscopy (SEM) and energy scattering X-ray spectroscopy (EDS).

Mix the prepared coated NCM523 with conductive agent, binder and solvent to prepare electrode slurry, then coat it on aluminum-based collector, dry to prepare electrode, and assemble the electrode into coin cells for electrochemical performance test.

(10) Cycle all coin cells first for 4 cycles at 2.75-4.4 V with 0.1 C, and then test for cycle life with 0.2 C using the same voltage range.

### Example 1 for Comparison

(1) The chemical formula of the electrode material used in this comparison example is LiNi_{0.5}Co_{0.2}Mn_{0.3}O₂ (NCM523 in brief).

(2) Characterize NCM523 by X-ray diffraction (XRD), scanning electron microscopy (SEM) and energy scattering X-ray spectroscopy (EDS).

(3) Mix NCM523 with conductive agent, binder and solvent to prepare electrode slurry, then coat it on aluminum-based collector, dry to prepare electrode, and assemble into coin cells for electrochemical performance test.

(4) Cycle all coin cells first for 4 cycles at 2.75-4.4 V with 0.1 C, and then test for cycle life with 0.2 C using the same voltage range.

### Example 2 for Comparison

(1) The coating material used in this comparison example is nano alumina (Al₂O₃), and the particle size of Al₂O₃ is 20-30 nm. The chemical formula of the electrode material used in this comparison example is LiNi_{0.5}Co_{0.2}Mn_{0.3}O₂ (NCM523 in brief).

(2) Take an appropriate amount of NCM523, add an appropriate amount of nano Al₂O₃, put them into the mixer and mix them for 3 to 8 hours.

(3) Heat the above mixture to 500° C. at a rate of 5° C./min, maintain at 500° C. for 10 hours, and then cool to room temperature with the furnace to complete the coating process.

(4) Disperse and sieve the samples to obtain the final Al₂O₃ coated electrode material.

(5) Characterize the synthesized samples by X-ray diffraction (XRD), scanning electron microscopy (SEM) and energy scattering X-ray spectroscopy (EDS).

(6) Mix NCM523 prepared by coating with conductive agent, binder and solvent to prepare electrode slurry, then coat it on aluminum-based collector, dry to prepare electrode, and assemble into coin cells for electrochemical performance test.

(7) Cycle all coin cells first for 4 cycles at 2.75-4.4 V with 0.1 C, and then test for cycle life with 0.2 C using the same voltage range.

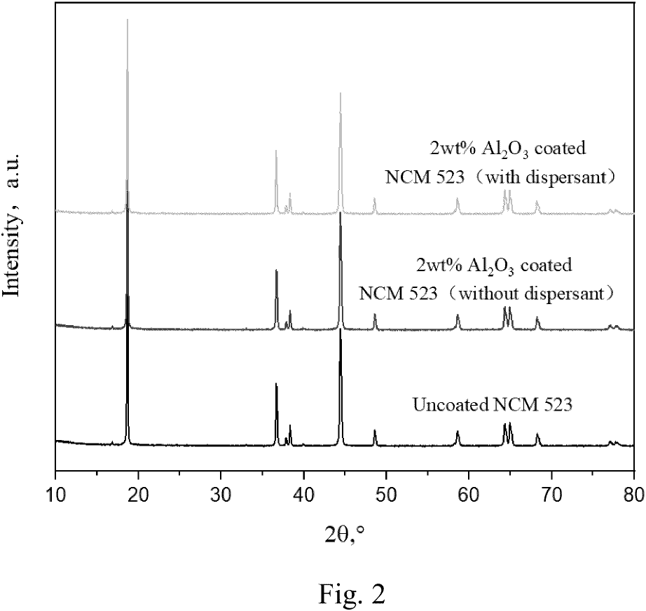

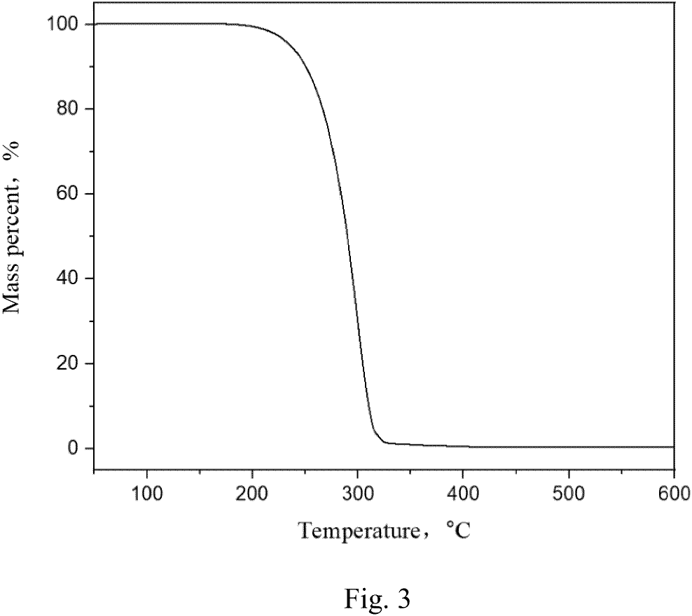

FIG. 2 is the XRD data of NCM523 material. As shown in FIG. 2, the X-ray diffraction (XRD) data show that the uncoated NCM523 is a pure R-3m layered structure. The XRD test for 2 wt% Al₂O₃ coated NCM523 material with stearic acid as dispersant shows that the coated NCM523 is also a pure R-3m layered structure. The data show that 2 wt% Al₂O₃ coating on NCM523 will not produce any impurity phase. Thermogravimetric analysis of stearic acid shows that stearic acid will gradually volatilize during solid-state synthesis. When the heating temperature is greater than 400° C., 100% of stearic acid will volatilize and decompose (see FIG. 3). Therefore, stearic acid as a dispersant will not introduce impurities in the coating process, nor will it affect the original battery material NCM523. The X-ray diffraction test in FIG. 2 shows that Al₂O₃ coated NCM523 with stearic acid also shows a pure R-3m layered structure.

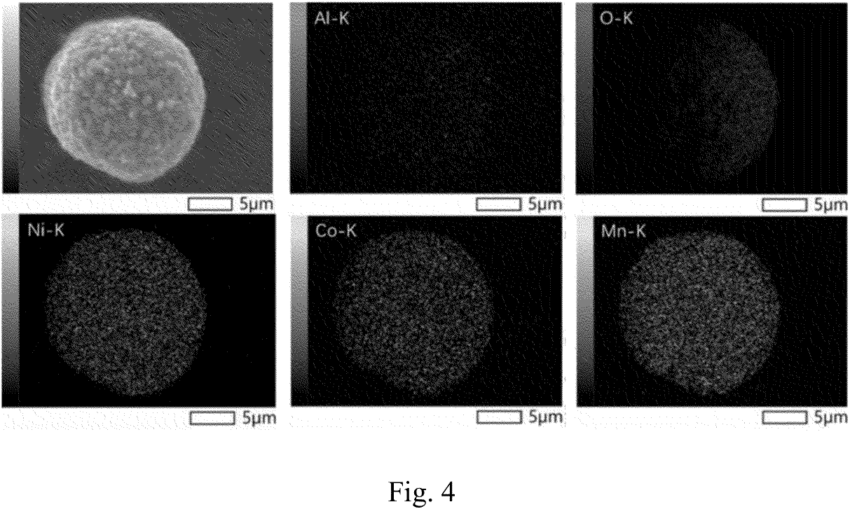

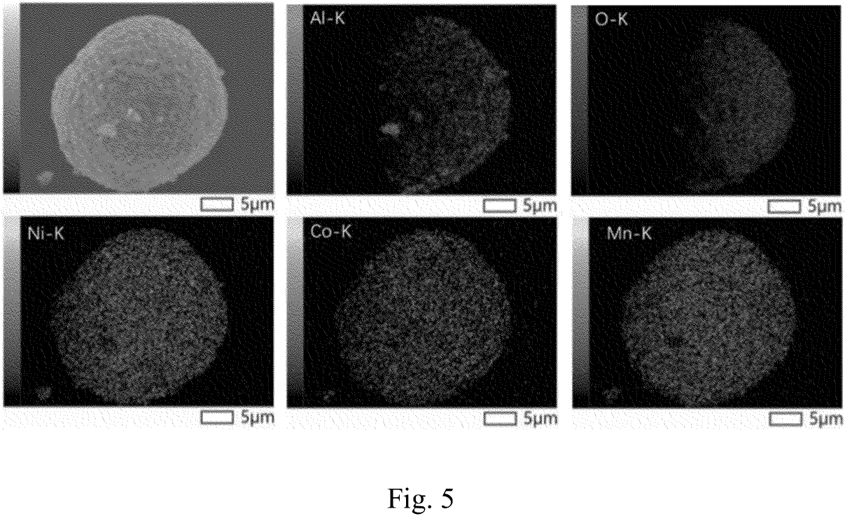

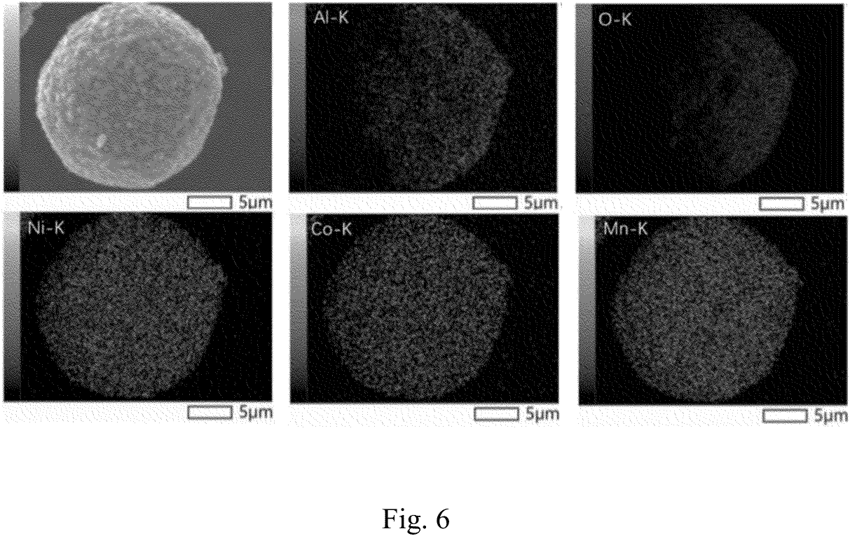

Scanning electron microscopy (SEM) and energy scattering X-ray spectroscopy (EDS) are conducted on these three samples above, the data are shown in FIG. 4, FIG. 5 and FIG. 6. NCM523 sample has spherical secondary particle morphology, and its particle size is roughly about 15 µm. Energy scattering X-ray spectrum element distribution analysis (EDS mapping) shows that nickel (Ni), cobalt (Co) and manganese (Mn) elements in uncoated NCM523 are evenly distributed on the particle surface, while the aluminum (Al) element signal is weak and basically negligible. For the coated samples prepared with or without stearic acid dispersant, the A1 signal can be clearly displayed on the surface of particles of electrode material. The Al element distribution in NCM523 sample using stearic acid as dispersant is evenly distributed on the surface of particles of electrode material (see FIG. 5). The distribution effect of Al element in NCM523 sample without dispersant is poor, and even agglomeration occurs. EDS mapping shows that stearic acid as a dispersant plays a positive role in the dispersion of Al₂O₃.

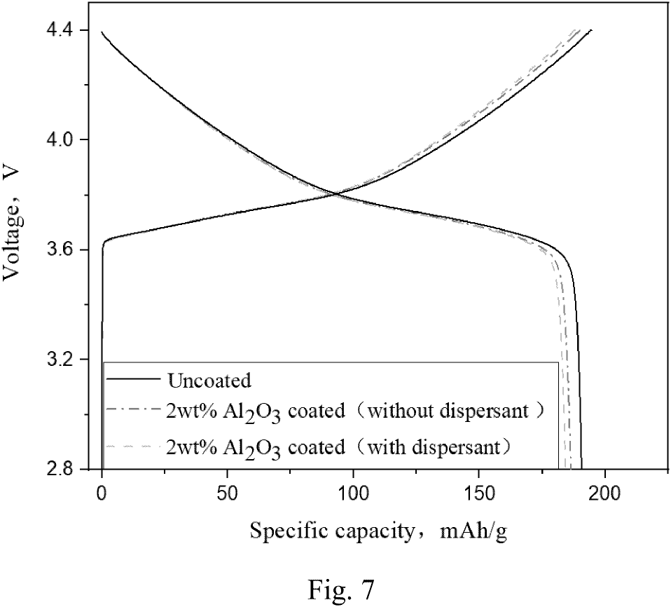

The charge and discharge curves of these three samples during the formation process are also compared (see FIG. 7). Since the coating material Al₂O₃ has no electrochemical activity, the specific discharge capacity of NCM523 coated with Al₂O₃ is slightly smaller than that of uncoated NCM523. At the same time, it is observed that although the coating weight ratio of Al₂O₃ is controlled to 2% with or without dispersant coating, the specific discharge capacity of NCM523 coated with dispersant is slightly less than that of NCM523 not coated with dispersant, which is due to the better coating effect of NCM523 coated with dispersant. At the same time, the comparison of cycle life shows that the cycle life of Al₂O₃ coated NCM523 is significantly higher than that of uncoated NCM523. The cycle life of NCM523 coated with stearic acid as dispersant is better. The comparison of cycle life shows that the use of stearic acid can greatly improve the uniformity of Al₂O₃ coating, so as to effectively improve the cycle life of electrode materials.

### Example 3

(1) The fatty acid used in this example is stearic acid, the coating material is nano alumina (Al₂O₃), and the particle size of Al₂O₃ is 20-30 nm. The chemical formula of the electrode material used in this example is LiNi_{0.5}Co_{0.2}Mn_{0.3}O₂ (NCM523 in brief).

(2) Firstly, prepare the mixture of 3 g stearic acid and nano Al₂O₃, in which the mass percentage of stearic acid is controlled at 3-30%.

(3) In the above mixture, add 10 to 30 g of ball milling beads for high-speed ball milling. The ball milling time is set from 1 to 5 hours and the ball milling speed is set from 100 to 600 rmp.

(4) After mixing is over, collect the mixture of stearic acid and nano Al₂O₃, that is, the coating precursor.

(5) Take an appropriate amount of NCM523 in batches and add the corresponding coating precursor (i.e. the mixture of stearic acid and nano Al₂O₃) to achieve the mass percentage of Al₂O₃ of 0.5%, 1% and 2%. Put NCM523 and coating precursor into a mixer and mix for 1 to 8 hours.

(6) Heat the above mixture to 200-1000° C. at a rate of 1-10° C./min, maintain at this temperature for 1-24 hours, and then cool to room temperature within the furnace to complete the coating process.

(7) Disperse and sieve the reaction products to obtain the final Al₂O₃ coated NCM523.

(8) Characterize the synthesized samples by X-ray diffraction (XRD), scanning electron microscopy (SEM) and energy scattering X-ray spectroscopy (EDS).

(9) Mix NCM523 prepared by coating with conductive agent, binder and solvent to prepare electrode slurry, then coat it on aluminum-based collector, dry to prepare electrode, and assemble into button battery for electrochemical performance test.

(10) Cycle all coin cells first for 4 cycles at 2.75-4.4 V with 0.1 C, and then test for cycle life with 0.2 C using the same voltage range.

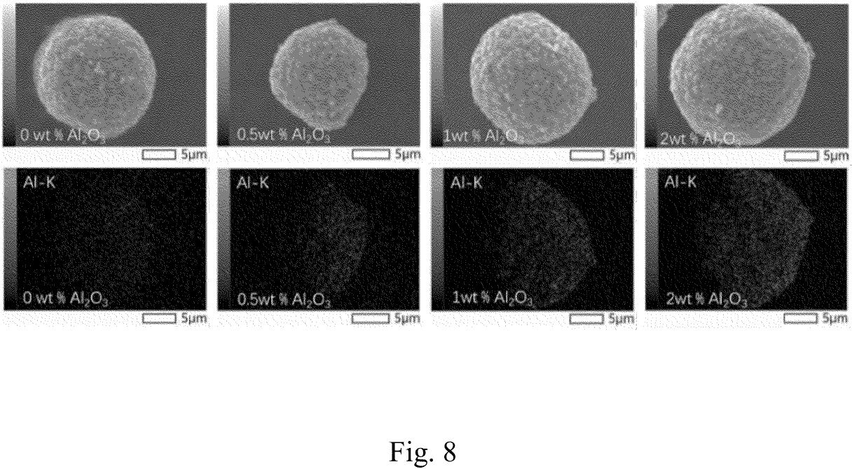

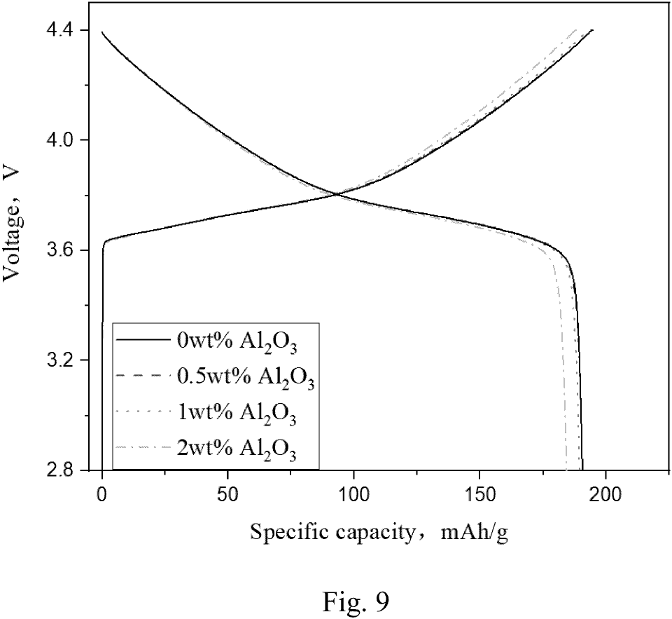

In this example, a comparison is made for the NCM523 particles coated with different amounts of Al₂O₃ using stearic acid dispersant. Stearic acid dispersant can be well used for Al₂O₃ coated electrode materials with various concentration ratios. The analysis of Al element distribution for samples with different Al₂O₃ coating amount shows that (see FIG. 8), all samples show uniform distribution of Al element, and the signal strength of Al element increases with the increase of Al₂O₃ coating amount. The charge/discharge curves of the three samples above and the uncoated NCM523 material during the formation process are compared (see FIG. 9). All samples show similar charge/ discharge curves, and the specific discharge capacity of NCM523 material decreases with the increase of Al₂O₃ coating amount. This example fully shows that the uniform distribution of coating material alumina can be realized in the process of coating NCM523 with different amounts of alumina using fatty acid as dispersant, which provides guarantee for adjusting the initial discharge capacity of NCM523 and improving the optimization of its cycle life.

### Example 4

(1) The fatty acid used in this example is lauric acid, the coating material is nano alumina (Al₂O₃), and the particle size of Al₂O₃ is 20-30 nm. The chemical formula of the electrode material used in this example is LiNi_{0.5}Co_{0.2}Mn_{0.3}O₂ (NCM523 in brief).

(2) Firstly, prepare the mixture of 3 g lauric acid and nano Al₂O₃, in which the mass percentage of lauric acid is controlled at 3-30%.

(3) In the above mixture, add 10 to 30 g of ball milling beads for high-speed ball milling. The ball milling time is set from 1 to 5 hours and the ball milling speed is set from 100 to 600 rmp.

(4) After ball milling is over, collect the mixture of lauric acid and nano Al₂O₃, i.e. coating precursor.

(5) Take an appropriate amount of NCM523 and add the corresponding coating precursor (i.e. the mixture of lauric acid and nano Al₂O₃), so that the mass percentage of Al₂O₃ is 2%. Put NCM523 and coating precursor into a mixer and mix for 1 to 8 hours.

(6) Heat the above mixture to 200-1000° C. at a rate of 1-10° C./min, maintain at this temperature for 1-24 hours, and then cool to room temperature within the furnace to complete the coating process.

(7) Disperse and sieve the reaction products to obtain the final Al₂O₃ coated electrode material.

(8) Characterize the synthesized samples by X-ray diffraction (XRD), scanning electron microscopy (SEM) and energy scattering X-ray spectroscopy (EDS).

(9) Mix NCM523 prepared by coating with conductive agent, binder and solvent to prepare electrode slurry, then coat it on aluminum-based collector, dry to prepare electrode, and assemble into button battery for electrochemical performance test.

(10) Cycle all coin cells first for 4 cycles at 2.75-4.4 V with 0.1 C, and then test for cycle life with 0.2 C using the same voltage range.

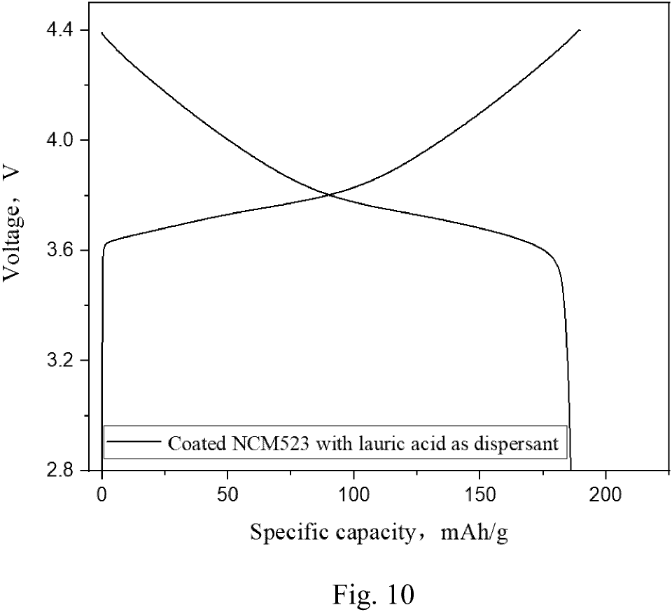

This example tests the coating effect of NCM523 particles using lauric acid as dispersant. The electrode material NCM523 can also be well coated with lauric acid as dispersant. The charge/discharge curve of NCM523 coated with Al₂O₃ using lauric acid dispersant is shown in FIG. 10.

### Example 5

(1) The fatty acid used in this example is lauric acid, the coating material is nano alumina (Al2O3), and the particle size of Al₂O₃ is 20-30 nm. The chemical formula of the electrode material used in this example is LiNi_{0.8}Co_{0.1}Mn_{0.1}O₂ (NCM811 in brief).

(2) Firstly, prepare the mixture of 3 g lauric acid and nano Al₂O₃, in which the mass percentage of lauric acid is controlled at 3-30%.

(3) In the above mixture, add 10 to 30 g of ball milling beads for high-speed ball milling. The ball milling time is set from 1 to 5 hours and the ball milling speed is set from 100 to 600 rmp.

(4) After ball milling is over, collect the mixture of lauric acid and nano Al₂O₃, i.e. coating precursor.

(5) Take an appropriate amount of NCM811 and add the corresponding coating precursor (i.e. the mixture of lauric acid and nano Al₂O₃), so that the mass percentage of Al₂O₃ is 2%. Put NCM811 and coating precursor into a mixer and mix for 1 to 8 hours.

(6) Heat the above mixture to 200-1000° C. at a rate of 1-10° C./min, maintain at this temperature for 1-24 hours, and then cool to room temperature within the furnace to complete the coating process.

(7) Disperse and sieve the reaction products to obtain the final Al₂O₃ coated electrode material.

(8) Characterize the synthesized samples by X-ray diffraction (XRD), scanning electron microscopy (SEM) and energy scattering X-ray spectroscopy (EDS).

(9) Mix NCM811 prepared by coating with conductive agent, binder and solvent to prepare electrode slurry, then coat it on aluminum based collector, dry to prepare electrode, and assemble into button battery for electrochemical performance test.

(10) Cycle all coin cells first for 4 cycles at 2.75-4.4 V with 0.1 C, and then test for cycle life with 0.2 C using the same voltage range.

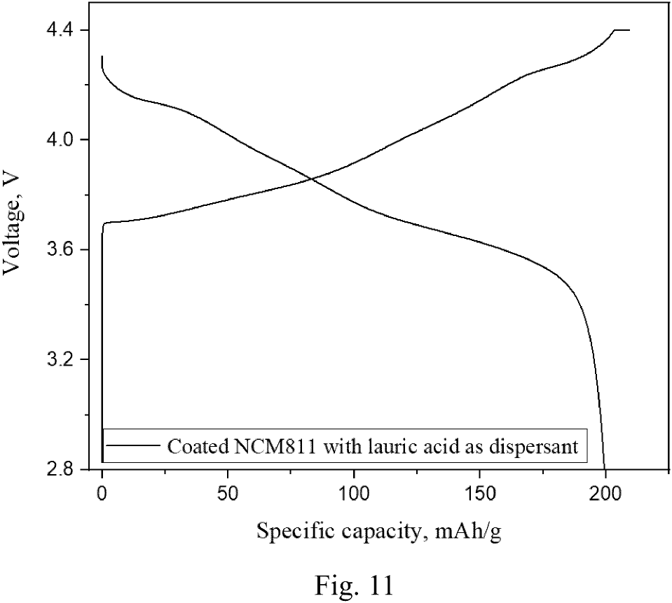

In this example, the coating effect of NCM811 particles with lauric acid as dispersant is tested. As shown in FIG. 11, the electrode material NCM811 can also be well coated with lauric acid as a dispersant.

1. The usage of a compound in the preparation of electrode materials for lithium-ion battery, it improves the coating uniformity of electrode materials prepared with solid-state method, wherein the said compound is C10-C34 fatty acid used as a dispersant in a preparation of electrode materials for lithium-ion battery,
the weight ratio of the electrode material to the coating material is 0.1~10 wt%,
the said electrode material of lithium-ion battery is shown in Li_{1±m}NiₓCo_{y}Mn_{z}M₁₋ₓ₋ _{y-z}O₂, wherein M is Cr, Mg, Al, Ti, Zr, Zn, CA, Nb and W, and m is 0.005 to 0.2; and x, y and z are independently selected from any number from 0 to 1,
the coating material is selected from one or more of the following groups of compounds:
metal oxides, including MgO, ZnO, CaO, BaO, A1₂O₃, Fe₂O₃, La₂O₃, TiO₂ and ZrO₂,
metal fluoride, including LiF, MgF₂, CaF₂ and AlF₃, and
metal carbonates, including Li₂CO₃, MgCO₃, CaCO₃ and Al₂(CO₃)₃.

2. (canceled)

3. (canceled)

4. The usage according to claim 1, wherein the said fatty acid is saturated fatty acid or unsaturated fatty acid.

5. The usage according to claim 1, wherein the said fatty acid is used as a regulator for the balance adjustment of the initial energy density of electrode material and improving the cycle life of electrode material.

6. The usage according to claim 1, wherein the said fatty acid is used as a regulator for personalized preparation of electrode materials for lithiumion battery according to the requirements of initial discharge and cycle life.

7. The usage according to claim 1, wherein the said fatty acid is shown as CH₃(CH₂)ₙCOOH, and n is an integer from 8 to 32.

8. The usage according to claim 7, wherein n is 8, 9, 10, 11, 12, 13, 14, 15, 16, 17, 18, 19, 20, 21, 22, 23, 24, 25, 26, 27, 28, 29, 30, 31 or 32.

9-11. (canceled)

12. The usage according to claim 1, wherein the said fatty acid is mixed with the coating material to make a coating precursor, which is sintered after mixing with the battery material, so that the coating material is evenly dispersed on the surface of the electrode material.

13. A method for preparing electrode material for lithium-ion battery is characterized by:
the coating precursor is prepared by mixing the compound with the coating material according to the weight ratio of 1:1~20, and then it is mixed with the lithium-ion battery material. The coating material is evenly dispersed on the surface of the electrode material of lithium-ion battery prepared by sintering. The said compound is C10-C34 fatty acid, and the ratio of the amount of the said coating material to the said lithium-ion battery material is 0.1~ 10 wt%,
the said electrode material of lithium-ion battery is shown in Li₁±ₘNiₓCo_{y}Mn_{z}M₁₋ₓ₋ _{y-z}O₂, wherein M is Cr, Mg, Al, Ti, Zr, Zn, CA, Nb and W, and m is 0.005 to 0.2; and x, y and z are independently selected from any number from 0 to 1,
the coating material is selected from one or more of the following groups of compounds:
metal oxides, including MgO, ZnO, CaO, BaO, A1₂O₃, Fe₂O₃, La₂O₃, TiO₂ and ZrO₂,
metal fluoride, including LiF, MgF₂, CaF₂ and AlF₃, and
metal carbonates, including Li₂CO₃, MgCO₃, CaCO₃ and Al₂(CO₃)₃.

14. The method according to claim 13, wherein the said sintering temperature is between 200° C. ~1000° C.

15. The method according to claim 14, wherein the said heating rate for the sintering is 1~10° C./min.

16. The method according to claim 14, wherein the said sintering is held from 2 hours to 24 hours.

17. The method according to claim 13, wherein the electrode material is in the form of powder.

18. The method according to claim 13, wherein the particle size of the said coating material is 10 nm~500 nm.

19. The method according to claim 13, wherein the fatty acid is saturated fatty acid or unsaturated fatty acid.

20. The method according to claim 13, wherein the fatty acid is shown as CH₃(CH₂)ₙCOOH, and n is an integer from 8 to 32.

21. The method according to claim 20 characterized in that the n is 8, 9, 10, 11, 12, 13, 14, 15, 16, 17, 18, 19, 20, 21, 22, 23, 24, 25, 26, 27, 28, 29, 30, 31 or 32.

22. (canceled)

23. (canceled)

24. A lithium-ion battery electrode, which is characterized in that it comprises a battery material and a coating material, and the coating material is evenly distributed on the surface of the battery material,
the weight ratio of the electrode material to the coating material is 0.1~10 wt%,
the said electrode material of lithium-ion battery is shown in Li_{1±m}NiₓCo_{y}Mn_{z}M₁₋ₓ₋ _{y-z}O₂, wherein M is Cr, Mg, Al, Ti, Zr, Zn, CA, Nb and W, and m is 0.005 to 0.2; and x, y and z are independently selected from any number from 0 to 1,
the coating material is selected from one or more of the following groups of compounds:
metal oxides, including MgO, ZnO, CaO, BaO, A1₂O₃, Fe₂O₃, La₂O₃, TiO₂ and ZrO₂,
metal fluoride, including LiF, MgF₂, CaF₂ and AlF₃, and
metal carbonates, including Li₂CO₃, MgCO₃, CaCO₃ and Al₂(CO₃)₃.

25. (canceled)

26. A lithium-ion battery comprising the lithium-ion battery electrode according to claim 24.
